(19) United States
(12) Patent Application Publication
(10) Pub. No.: US 2023/0294534 A1
(43) Pub. Date: Sep. 21, 2023

(54) In-Ground Electric Vehicle Charging Module

(71) Applicant: Nicholas Anthony Gallucci, Los Angeles, CA (US)

(72) Inventor: Nicholas Anthony Gallucci, Los Angeles, CA (US)

(21) Appl. No.: 18/185,975

(22) Filed: Mar. 17, 2023

Related U.S. Application Data
(60) Provisional application No. 63/269,529, filed on Mar. 17, 2022.

(51) Int. Cl. B60L 53/30; H02J 7/00; B60L 53/18; B60L 53/68

(52) U.S. Cl. CPC B60L 53/30; B60L 53/18; B60L 53/305; B60L 53/68; H02J 7/0042; H02J 7/0047

(57) ABSTRACT

Charging modules and systems capable of being installed in the parkways of houses (such that private home chargers and home electrical systems can be extended to street parking locations are provided. Such charging modules and systems may be configured to be located at ground level in parkways adjacent to streets such that EV chargers can be installed for private use even in the absence of off-street parking.

### CROSS REFERENCE TO RELATED APPLICATIONS

The application claims priority to U.S. Provisional Application No. 63/269,529, filed Mar. 17, 2022, the disclosure of which is incorporated herein by reference.

### FIELD OF THE INVENTION

This application generally refers to parkway charging modules and systems for electric vehicles (EV). More specifically, this application relates to universal EV charging modules and systems that allow for the installation and adaptation of a variety of EV chargers.

### BACKGROUND

As EVs are increasingly adopted as a primary means of transport, the infrastructure needed to charge the increasing number of EVs will also need to expand. At present charging stations fall into one of two broad categories, public charging stations that are generally set up in areas accessible by the public such as parking lots and dedicated charging stations, and private chargers, which are usually attached to homes. In order to meet projected demand, the number and distribution of both public and private EV charging stations will need to be increased.

### SUMMARY OF THE INVENTION

Modules and systems in accordance with some embodiments of the invention are directed to universal EV charging .

Various embodiments are directed to EV charger modules, including:
an enclosure having a plurality of sidewalls defining an enclosure perimeter configured to contain an EV charger, a permeable bottom, and a cover configured to provide external access to said enclosure and at least one outlet for a power chord from the EV charger to extend therefrom to an external environment;
a power feedthrough disposed in at least one of the sidewall or bottom such that power from an external power source may be introduced therein;
a waterproof internal compartment disposed within the enclosure and positioned such that the power feedthrough terminates therein; and
an electrical box disposed within the internal compartment and disposed to interface with the power feedthrough and configured to adapt the power from the power feedthrough such that it is electrically compatible with the EV charger.

In still various embodiments, the waterproof compartment comprises a top wall, a plurality of side walls, such that only a bottom portion of the waterproof compartment is open.

In yet various embodiments, at least one of the plurality of side walls or the top wall are openable to provide access to the waterproof compartment.

In still yet various embodiments, the cover is pivotably connected to at least one of the sidewalls, and wherein at least one edge of the cover and the adjacent sidewall are lined with an anti-pinch cord gap material such that the power chord can extend therethrough while the cover is in a closed position seated with the sidewalls of the enclosure.

In yet still various embodiments, the module further comprises a relay configured to control the flow of power to the electrical box.

In still yet various embodiments, the relay further comprises at least one power monitoring element configured to record at least one of either the voltage or the current.

In yet still various embodiments, the relay further comprises a communication element configured to communicate the status of the module to an external user.

In still yet various embodiments, the communication element is configured to communicate through a connection selected from the group consisting of a hardwired cable, Wi-Fi, cellular connection, a satellite connection, or a radio signal.

In yet still various embodiments, the communication element is configured to control the power to the electrical box via a signal from the external user.

In still yet various embodiments, the relay is disposed within the waterproof internal compartment between the power feedthrough and the electrical box.

In yet still various embodiments, the relay is disposed external to the enclosure.

In still yet various embodiments, the enclosure is waterproof.

In yet still various embodiments, the enclosure is configured to be installed underground such that the cover is flush with a top surface of the ground.

In still yet various embodiments, the enclosure further comprises a system to manage a power chord from the EV charger.

In yet still various embodiments, the system includes a coiling element configured to coil the power chord in a roll.

In still yet various embodiments, the cover further comprises a locking element configured to secure the cover when in a closed position.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIG. 1 illustrates a schematic of a typical home layout and EV charger module location in accordance with embodiments.

FIG. 2 illustrates a cross-section schematic of a typical home layout and EV charger module location in accordance with embodiments.

FIG. 3 illustrates a cross-section schematic of an EV charger module in accordance with embodiments.

FIG. 4 illustrates a top view schematic of an EV charger module in accordance with embodiments.

FIG. 5 illustrates a top view schematic of an EV charger module cover in accordance with embodiments.

### DETAILED DESCRIPTION OF THE INVENTION

Electric vehicle (EV) chargers are becoming an increasingly important element of infrastructure as the transportation sector becomes increasingly electrified. While the growth of public chargers is being driven by the government sector and private corporations capable of obtaining the necessary locations, the growth of private or home charger installations is being stalled by the design of many homes. Specifically, at present most private chargers can only be located in homes that have dedicated garages or off-street parking spaces. While newer homes typically have suitable locations, many older homes and multi-family homes do not. In these homes parking is usually only found on the street where it is not possible to install a conventional home charger.

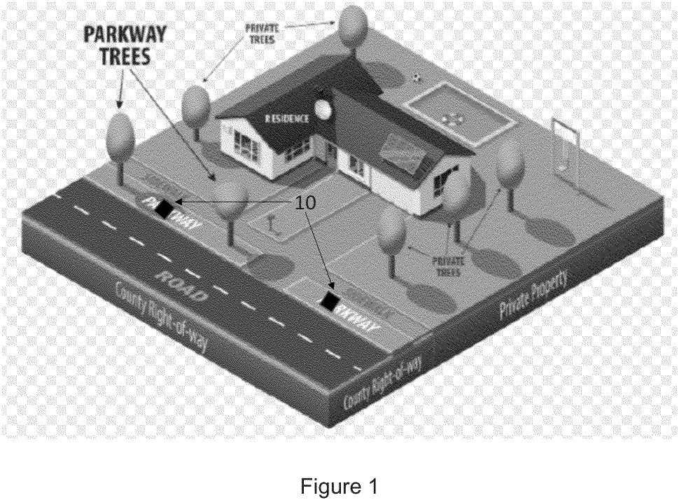

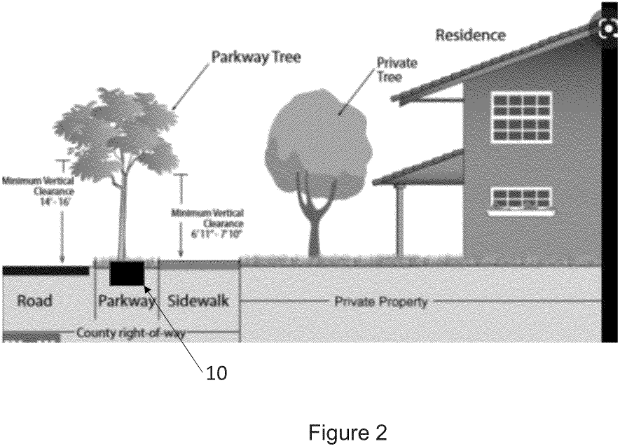

Embodiments of the current disclosure provide charging modules and systems capable of being installed in the parkways of houses (as shown in FIGS. 1 and 2) such that private home chargers and home electrical systems can be extended to street parking locations. As shown, in many embodiments such charging modules and systems (10) are configured to be located in the ground such that the top cover is flush with ground level. By allowing the modules and systems to be installed such that they do not interfere with or obscure the space above the ground, the modules and systems according to embodiments may be positioned in parkways adjacent to streets such that EV chargers can be installed for private use even in the absence of off-street parking.

Currently, home chargers are not designed for installation on public right-of-ways, such as, for example, in street-side parkways. Many, for example, or designed to be attached to a wall or extend upward from the ground. As a result, even were a homeowner to obtain a suitable public works permit (such as an A, U, UFD, etc.), the installed charger would both interfere with public usage and access to the parkway, and also be vulnerable to interference or use by other members of the public. Embodiments of the disclosure address these challenges by providing an EV charging module that is configured to be installed flush to the ground within a parkway or other street-side setting and to provide secure access to power at that location. Moreover, many embodiments provide that the EV charging modules are provide a universal connection to the power grid such that any EV charger may be used with it. Finally, various embodiments also allow for securing access both to the physical module and to the source of power such that the supply of power and even billing related to power consumption from the module may be monitored and controlled by the owner of the module.

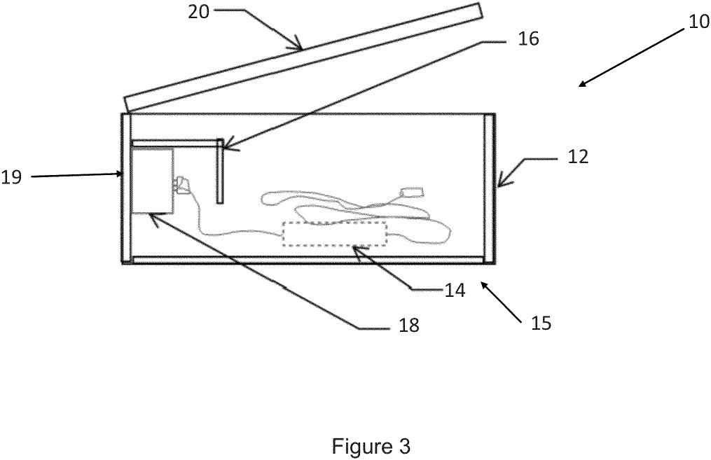

Turning to the figures, in many embodiments an EV charger module, as shown in FIGS. 3 to 5, is comprised of a plurality of sidewalls (12) and a bottom (15) defining an enclosure (10) configured to contain a desired EV charger (14). In aspects of such embodiments, the enclosure is waterproof with a Nema/IP rating section to allow PEVC to be installed in locations that have wet ground conditions. In many such embodiments, the bottom wall of the enclosure is permeable such that any water that does enter the enclosure is drained into the surrounding ground. The cover (20) to the module, in accordance with many embodiments is configured to seal the enclosure in a first position and provide access to the enclosure in a second position, while also allowing an outlet for a charging cord from the EV charger (14) to extend out into the external environment. It will be understood that although a schematic EV charger (14) of a specific configuration is depicted being enclosed within the module that the module and system according to embodiments is configured to be compatible with any EV charger that is electrically compatible with the power directed into the module. In addition, although not shown in the figures, the EV charger enclosure may further comprise a system to manage a power chord from the EV charger (14), such as, for example, a coiling element configured to coil the power chord in a roll.

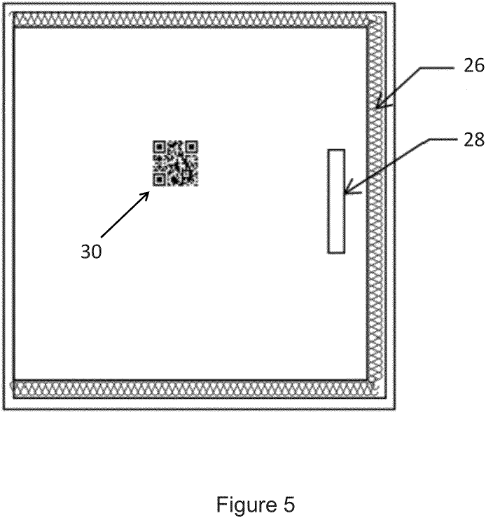

In some embodiments, as shown in FIGS. 3 and 5, the enclosure cover (20) is pivotably connected to at least one of the sidewalls (12), and wherein at least one edge of the cover and the adjacent sidewall may be lined with an anti-pinch cord gap material (26) such that an EV charger power chord can extend therethrough while the cover is in a closed position seated with the sidewalls of the enclosure. The cover may also include a handle (28) to allow the opening and closing of the cover, and a locking element (not shown) to allow the enclosure to be secured. In some such embodiments the cover may be flush with the cover such that the overall system is flush with the ground as previously described.

Enclosures according to many embodiments further comprise an internal waterproof compartment (16) that is positioned such that a power feedthrough (19) connected to an external power source terminates within it. Although the figures show the power feedthrough as being positioned in one of the sidewalls of the enclosure, it will be understood that the feedthrough could also be positioned within the bottom of the enclosure such that power from the external power source is introduced into the enclosure. In various embodiments, as shown in FIG. 3, the waterproof compartment may comprise an open structure such that it is formed of a top wall and a plurality of side walls, and such that only a bottom portion of the waterproof compartment is open. In such embodiments the compartment is made waterproof by the air pocket created by the top and sidewalls of the compartment. In other embodiments, the waterproof compartment is fully enclosed. In various such embodiments a portion of the waterproof compartment may have an openable portion (e.g., the top or one of the sidewalls) to provide access to the compartment. The cover may also incorporate a labelling element (30), such as, for example, a bar code or other element to allow quick identification or activation of the charging element.

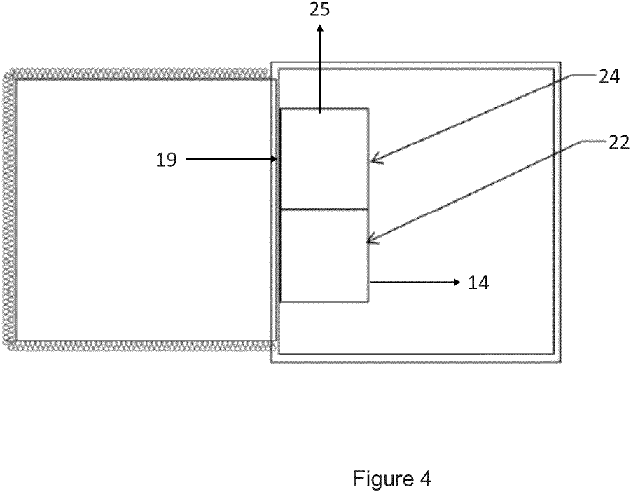

In various embodiments electrical components may be included in the waterproof compartment, as shown in FIG. 4. Such electrical components may provide all the hardware necessary to take incoming power from the power feedthrough and transform it for use with a conventional EV charger. Electrical components may also be provided capable of monitoring and controlling power to the EV charger. In many embodiments, the electrical components may comprise an electrical box (22) disposed within the internal compartment and disposed to interface with the power feedthrough and configured to adapt the power from the power feedthrough such that it is compatible with the EV charger. In many such embodiments, such adaptation may include conversion from 240V to 120V, and or to alter the amperage as necessary to interface with the EV charger.

The electrical components may further comprise a relay configured to control the flow of power to the electrical box (22) to thereby also control or disable the use of the EV charger. In various embodiments, the relay (24) may be disposed within the waterproof internal compartment between the power feedthrough (19) and the electrical box. In such embodiments, the input may be unswitched and the output to the EV charger (14) may be switched on and off from a controller that controls the relay. The relay may further comprise at least one power monitoring element configured to record at least one of either the voltage or the current (e.g., through appropriate sensors). The relay may further comprise a communication element (25) configured to communicate the status of the module to an external user. Such communication elements may be configured to communicate through a connection selected from the group consisting of a hardwired cable, Wi-Fi, cellular connection, a satellite connection, or a radio signal. The communication element may also configured to control the power to the electrical box via a signal from the external user. In such embodiments the user may control the relay through the communication element via software control interface. Such control may include on/off functionality, voltage/current monitoring, and/or billing monitoring. Although the embodiments shown in FIGS. 3 and 4 have the relay disposed within the enclosure, it will be understood that the relay may be disposed external to the enclosure.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ± 10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1 %, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. An EV charger module, comprising:
an enclosure having a plurality of sidewalls defining an enclosure perimeter configured to contain an EV charger, a permeable bottom, and a cover configured to provide external access to said enclosure and at least one outlet for a power chord from the EV charger to extend therefrom to an external environment;
a power feedthrough disposed in at least one of the sidewall or bottom such that power from an external power source may be introduced therein;
a waterproof internal compartment disposed within the enclosure and positioned such that the power feedthrough terminates therein; and
an electrical box disposed within the internal compartment and disposed to interface with the power feedthrough and configured to adapt the power from the power feedthrough such that it is electrically compatible with the EV charger.

2. The EV charger module of claim 1, wherein the waterproof compartment comprises a top wall, a plurality of side walls, such that only a bottom portion of the waterproof compartment is open.

3. The EV charger module of claim 2, wherein at least one of the plurality of side walls or the top wall are openable to provide access to the waterproof compartment.

4. The EV charger module of claim 1, wherein the cover is pivotably connected to at least one of the sidewalls, and wherein at least one edge of the cover and the adjacent sidewall are lined with an anti-pinch cord gap material such that the power chord can extend therethrough while the cover is in a closed position seated with the sidewalls of the enclosure.

5. The EV charger module of claim 1, wherein the module further comprises a relay configured to control the flow of power to the electrical box.

6. The EV charger module of claim 5, wherein the relay further comprises at least one power monitoring element configured to record at least one of either the voltage or the current.

7. The EV charger module of claim 5, wherein the relay further comprises a communication element configured to communicate the status of the module to an external user.

8. The EV charger module of claim 7, wherein the communication element is configured to communicate through a connection selected from the group consisting of a hardwired cable, Wi-Fi, cellular connection, a satellite connection, or a radio signal.

9. The EV charger module of claim 7, wherein the communication element is configured to control the power to the electrical box via a signal from the external user.

10. The EV charger module of claim 5, wherein the relay is disposed within the waterproof internal compartment between the power feedthrough and the electrical box.

11. The EV charger module of claim 5, wherein the relay is disposed external to the enclosure.

12. The EV charger module of claim 1 wherein the enclosure is waterproof.

13. The EV charger module of claim 10, wherein the enclosure is configured to be installed underground such that the cover is flush with a top surface of the ground.

14. The EV charger module of claim 1, wherein the enclosure further comprises a system to manage a power chord from the EV charger.

15. The EV charger module of claim 14, wherein the system includes a coiling element configured to coil the power chord in a roll.

16. The EV charger module of claim 1, wherein the cover further comprises a locking element configured to secure the cover when in a closed position.

17. An EV charger module, comprising:
an enclosure having a plurality of sidewalls defining an enclosure perimeter configured to contain an EV charger, a permeable bottom, and a cover configured to provide external access to said enclosure and at least one outlet for a power chord from the EV charger to extend therefrom to an external environment;
a power feedthrough disposed in at least one of the sidewall or bottom such that power from an external power source may be introduced therein;
a waterproof internal compartment disposed within the enclosure and positioned such that the power feedthrough terminates therein;
an electrical box disposed within the internal compartment and disposed to interface with the power feedthrough and configured to adapt the power from the power feedthrough such that it is electrically compatible with the EV charger; and
a relay disposed within the internal compartment and configured to control the flow of power to the electrical box.

18. The EV charger module of claim 17, wherein the waterproof compartment comprises a top wall, a plurality of side walls, such that only a bottom portion of the waterproof compartment is open.

19. The EV charger module of claim 18, wherein at least one of the plurality of side walls or the top wall are openable to provide access to the waterproof compartment.

20. The EV charger module of claim 17, wherein the cover is pivotably connected to at least one of the sidewalls, and wherein at least one edge of the cover and the adjacent sidewall are lined with an anti-pinch cord gap material such that the power chord can extend therethrough while the cover is in a closed position seated with the sidewalls of the enclosure.
